(19) United States
(12) Patent Application Publication
(10) Pub. No.: US 2025/0021210 A1
(43) Pub. Date: Jan. 16, 2025

(54) Method and System for Facilitating and Tracking a User's Traversal Through Information

(71) Applicant: CollegeNET, Inc., Portland, OR (US)

(72) Inventors: James H. Wolfston, JR., Portland, OR (US); Herts Chen, Portland, OR (US); Stuthi Neal Vennapusapalle, Portland, OR (US)

(21) Appl. No.: 18/773,142

(22) Filed: Jul. 15, 2024

Related U.S. Application Data
(63) Continuation-in-part of application No. 18/626,028, filed on Apr. 3, 2024.
(60) Provisional application No. 63/526,895, filed on Jul. 14, 2023.

(51) Int. Cl. G06F 3/0482; G09B 5/02; G09B 5/06

(52) U.S. Cl. CPC G06F 3/0482; G09B 5/02; G09B 5/065

(57) ABSTRACT

A communications system for traversing multimedia content that can be augmented in stacked windows of information is disclosed. The system includes an interactive graphical user interface operable on a device of a user, wherein the device is in communication with a server to access or provide communicated content, and wherein the graphical user interface generates and an interactive menu of a plurality of types of communication functions from which the user can select, wherein the graphical user interface is responsive to the user. The system iteratively generates new stacked windows as additional selections for more information are made from windows previously generated in the stack.

### CROSS REFERENCE TO RELATED APPLICATIONS

This application claims the benefit of priority from U.S. Provisional Application No. 63/526,895, filed Jul. 14, 2023, and is further a continuation-in-part of U.S. patent application Ser. No. 18/626,028, filed Apr. 3, 2024. The foregoing related applications, in their entirety, are incorporated herein by reference.

### TECHNICAL FIELD

The following disclosure relates to methods and systems for asynchronous learning, and more particularly, to methods and systems for facilitating dynamic interaction with information presented during a user's course of study.

### BACKGROUND

People ingest information and acquire knowledge by listening to others and/or by reading written materials. Whether for academics, business, or simply for personal development, people typically learn through a combination of oral and written communications. For example, in an academic environment, students are typically tasked with reading assignments from textbooks and attending lectures provided by faculty in classrooms. In business settings, employees may review memos, reports, and other written materials, and also attend business meetings or presentations. While oral and written communications can be effective (individually or in combination), there can be various challenges associated with digesting and retaining information, whether provided in oral presentations or in conventional written media.

As a first matter, there can be logistical problems and various other limitations that tend to reduce the value of attending live meetings and lectures. Whether in-person or remote, the participants in a meeting/discussion must coordinate so as to be on the same schedule, at the same time. Whether the meeting is in a conference room, classroom, webinar, etc., those who wish to actively participate must be in simultaneous attendance. For those who are available to attend a meeting or lecture, they might nonetheless misunderstand (or altogether miss) some of the salient points that were discussed. If attendees need to recall particular points of discussion, they might take notes, either on paper or electronically, but those notes might not adequately capture what had been discussed and can be difficult to organize, particularly when they are jotted down in real time. Presenter slides can be helpful but often distract the listener from what is being said. Also, during live presentations, participants' questions, comments, etc. may disrupt the presenter. In some instances, such disruptions might create difficulties for the presenter or might cause unwelcomed distractions for others in attendance. In many instances, an attendee will not be “called on” or given adequate opportunities ask questions or provide comments.

Conventional oral presentations or lectures can be recorded for later viewing, but that does not enable active participation. For example, a classroom lecture can be recorded by video or a webinar can be recorded for later playback on-demand. In these scenarios, those who watch later cannot be more than a passive observer. Once the recording has been made, the meeting, lecture, class, etc. has concluded. Additionally, if a person is interested in just a segment of a recorded conversation, that person needs to remember at what time that segment of the meeting had occurred. The route and steps through which a person thinks about, explores, and traverses through presented information is not recorded. And to the extent the person wishes to record information as they traverse and absorb it, that person must simultaneously engage in some kind of record-keeping or note taking. This can distract from the learning task.

There are also various limitations on the effectiveness of conventional written communications. Articles, textbooks, and other publications can include errors or may be out of date. Books and other printed media typically leave little room on the pages for taking notes. If a reader has questions or otherwise seeks more information about a passage in written text, the reader must manually search other sources for that information. And even if the reader can find the information in another source, unless the reader manually places information from different sources into the same folder (either a paper folder or an electronic one), the reader's research will be disorganized and likely forgotten.

Over the past thirty years, the Internet has provided almost limitless potential for accessing information from various sources about almost any topic imaginable. Internet users use search engines to locate websites relevant to their interests and users can “surf the web” by searching through various websites or using hyperlinks to access many more websites that might be of interest to the user. But to learn more information about something that is discussed on a website, users may have to exit the website and run separate searches. And search engines and web browsers do not provide a capability for a user to organize, track, or archive a user's searching and research.

These inherent limitations associated with conventional oral presentations and written and online communications create disincentives for people to engage in creative thinking and fully engage in their curiosity. Furthermore, these limitations make it difficult for users to archive their research for later review.

### SUMMARY

A communications system for traversing multimedia content that can be augmented in stacked windows of information is disclosed. The system includes an interactive graphical user interface operable on a device of a user. The device is in communication with a server to access or provide communicated content. The graphical user interface generates a display that includes in a first window: a video region for playing a video communication of communicated content, text associated with the video communication, and an interactive menu of a plurality of types of communication functions from which the user can select. The graphical user interface is responsive to the user (i) highlighting a text excerpt, and (ii) selecting, from the interactive menu, a type of communication function to be associated with the highlighted excerpt. The graphical user interface augments the communicated content into a second window to be stacked in a manner offset and atop the first window to provide additional information on the user's display based upon the type of function that the user selects from the interactive menu and the highlighted text excerpt from the synchronized transcript, and depending upon the selected type of communication function, wherein the stacked information is created according to branches and levels that can be navigated in forward or reverse order. The interactive menu is further responsive to the user highlighting a text excerpt from the second window and selecting a type of communication function, to cause further stacking of additional windows that provide additional information.

### BRIEF DESCRIPTION OF THE FIGURES

FIG. 1 is a block diagram illustrating an example message thread generated using an asynchronous learning system 304 according to at least one embodiment, in accordance with an embodiment of the disclosure.

FIG. 2 is a block diagram illustrating an example data structure for generated message threads within an asynchronous learning system, in accordance with an embodiment of the disclosure.

FIG. 3 illustrates an example computer-implemented environment wherein users can interact with an asynchronous learning system, in accordance with an embodiment of the disclosure.

FIG. 4 is an example screen of an interactive GUI of an asynchronous learning system, in accordance with an embodiment of the disclosure.

FIG. 5 is another example screen of an interactive GUI displaying an example timeline of generated threads having message alerts, in accordance with an embodiment of the disclosure.

FIG. 6 is another example screen of an interactive GUI of a recipient user of a thread, in accordance with an embodiment of the disclosure.

FIG. 7 is another example screen of an interactive GUI displaying a menu of communication function options available to the user with the user selecting a “Disagree” option, in accordance with an embodiment of the disclosure.

FIG. 8 is another example screen of an interactive GUI displaying annotation options available to the user with the user selecting a “look up” option, in accordance with an embodiment of the disclosure.

FIG. 9 is an example screen of an interactive GUI displaying an interaction by the user after having selected an “Ask” option.

FIG. 10 is another example screen of an interactive GUI displaying communication function options available to the user with the user selecting the “Ask” option.

FIG. 11 is an example screen of an interactive GUI displaying submitting an annotation, in this case, a question.

FIG. 12 illustrates a graphical user interface (GUI) that has been configured for use with a fractal menu.

FIG. 13 illustrates an example of how the graphical user interface of FIG. 12 is configured to respond to a first level drill down operation, according to various embodiments.

FIG. 14 illustrates a graphical user interface depicting how the text information in pop up is “stacked” in response to the GUI receiving a user-selection to “stack” the additional information.

FIG. 15 illustrates a graphical user interface depicting how stacked information can be navigated for a vocabulary function.

FIG. 16 illustrates another stacked view in a graphical user interface, with a window having a third level of information based upon the user's request for a definition of a term that appeared in the second level of information.

FIG. 17 illustrates a tree view of the information from FIG. 16.

FIG. 18 illustrates a stacking arrangement in a graphical user interface when the user selects to create a new branch with information that already was provided.

FIG. 19 illustrates an example of a user's interaction with the graphical user interface display of FIG. 18.

FIG. 20 is an example of a graphical user interface where additional information regarding text from a different branch and level are presented.

FIG. 21 is an example display of a tree view that includes all of the stacked text windows of FIG. 20, in accordance with an embodiment of the disclosure.

FIG. 22 is an example of a stacked layout in a graphical user interface, in accordance with an embodiment of the disclosure.

FIG. 23 illustrates creation of a branch in a stacked layout in a graphical user interface, in accordance with an embodiment of the disclosure.

FIG. 24 is an example of a tree view in a graphical user interface, in accordance with an embodiment of the disclosure.

FIG. 25 is a further example of a tree view in a graphical user interface, in accordance with an embodiment of the disclosure

FIG. 26 is an example of the stacked view of the graphical user interface from FIG. 25, in accordance with an embodiment of the disclosure.

FIG. 27 is an example of a user's interaction in a graphical user interface with the stacked view of FIG. 26, in accordance with an embodiment of the disclosure.

FIG. 28 is an example of a tree view with a window provided in response to a user selecting to receive more detail about a displayed node, in accordance with an embodiment of the disclosure.

FIG. 29 is an example stacked view of a graphical user interface with a copy of a window associated with a branch, in accordance with an embodiment of the disclosure.

FIG. 30 is an example stacked view of a graphical user interface with a lookup operation performed, in accordance with an embodiment of the disclosure.

### DETAILED DESCRIPTION

In accordance with various embodiments, the present disclosure is directed to an asynchronous communications system that facilitates a user to review information and perform drill-downs to learn more detailed information or otherwise take actions regarding selected text, phrases, or excerpts of information being reviewed. The system is further configured to track the user's traversal through those drill-down actions and visually represent the user's course of study on a display.

### Drill-Downs on Information Reviewed

Various embodiments of the present disclosure are directed to a novel graphical user interface that facilitates interactive, asynchronous learning. The graphical user interface displays a window that presents textual information for the user to review and a menu of user-selectable communications functions by which the user can interact with the presented textual information. The menu enables a user to perform drill-downs on textual information being reviewed. This can be a pop-up or persistent menu. Using the graphical user interface, the user can highlight (select) a word, phrase, or excerpt from a first level of information being provided in a window on the display, and can select from the menu an exploration, communication, or drill-down function (herein, “communication function”) to be performed on the highlighted text on the display. As an example, the user may select from the menu a request to obtain definitions for the term or terms in the highlighted text. In some embodiments, after highlighting the text, the menu is then automatically displayed to prompt the user's selection of a communication function.

Upon receiving the user's selections, the graphical user interface displays a second level of additional information, in a second window, that is based on the text highlighted from the first level of information.

Upon reviewing the second level of additional information in the second window, the user can highlight (select) a word, phrase, or excerpt from this second level of additional information. The user can use the menu again to select a communication function to operate, this time on the highlighted text from the second level of additional information in the second window. This will prompt the graphical user interface to provide a third level of additional information, in a third window, that is based on the text highlighted from the second level of information in the second window. This drill down activity can be carried forward to the fourth level, fifth level, and so on.

The graphical user interface can be configured such that the operations for highlighting text and selecting communication functions from the menu to generate yet another level of information in another window can continue ad infinitum. In this manner, a user can continue to request more information or explanations about one or more topics or issues in the textual information being presented, until the user becomes satisfied with the depth of his or her level of understanding.

The process of highlighting text and selecting a communication function to operate on the highlighted text can be referred to as a “drill-down operation” because it causes the system to obtain more detailed or particular information according to the selected menu function.

### Fractual Menuing for Performing Drill-Downs

The process of providing a menu from which communication functions (e.g., drill down operations) can be performed on multiple levels of information can be referred to as “fractal menuing.” A fractal is known to be a type of geometric shape that is infinitely scalable with a pattern that repeats forever, such that every part of the fractal appears very similar to the whole image, regardless of the level of zoom-in or zoom-out. Put another way, a fractal is a never-ending repeating pattern regardless of the scale of observation. It can be said that fractals enable one to “understand the universe” because the shape can be continually studied at greater and greater levels of detail while still appreciating the overall shape at the most basic level. Thus, one can evaluate a fractal by performing never-ending “drill down operations” on any selected portion of the pattern.

While a fractal is a geometric shape, in the present application, the concept can be applied to the study of textual information, in which a person can repeatedly “drill down” into different levels of information utilizing the same menu and interface. A persistent menu can be considered a “fractal menu” because it provides the same mechanism by which a user can drill down deeper and deeper into the information.

Thus, with fractal menuing, a user can review a text passage and select an excerpt that is of particular interest and then use the menu to look up its definition or other information about that excerpt. From there, the user can use the menu to look up the definition of an excerpt from the definition, and so on. This enables a user to go deeper and deeper to facilitate a greater understanding while still recognizing how that deeper information fits into context with the original passages of information that the user was earlier reviewing.

Drill Down Information can be Obtained from Various Sources

In some embodiments, a user can select to have a communication function (e.g., drill down function) performed on any word, phrase, or excerpt from the text passage in a window. In that manner, the user can learn more information about anything and everything that has been presented to the user. In short, the user has the freedom to explore and question everything at any level of depth.

In some embodiments the system can be configured to retrieve information from one or more sources. These sources can be arranged in a hierarchy. In one example, upon receiving a request to define a highlighted word, the system retrieves definitions from one or more dictionaries. In another example, the system can be configured to first check for additional information in one or more designated textbooks. This can be particularly useful if the system is utilized in an academic environment. For example, if the textual information is a transcription from a teacher or professor's lecture, that instructor can conFIG. the system to consult with one or more textbooks for the course or other texts that have been approved by the instructor. In still another example, the system can be configured to retrieve information using an artificial intelligence platform. In addition to providing the requested additional information, the system can indicate (to the user) the source of this information. In some configurations, the system can enable the user to select which source of information should be consulted, or the system can provide information from more than one source.

### Archiving Traversals Through the Drill-Downs

The system catalogs and stores each drill down operation along with the additional information that was requested and provided, thereby preserving a record of the user's research operations and investigations. From this, when the user reviews the information at a later date (perhaps when studying for an exam), the user can be instantly reminded of what additional information was sought and what was provided so that the user can regain his or her full understanding from before, and continue moving forward from where the user had left off.

The First Level of Text Information can be from Various Sources

As will be described below in further detail with reference to FIG.s, the system according to one or more embodiments provides a first window that includes the first level of text information that the user is reviewing. In some embodiments, the text passages in the first window can be a transcription of a video/oral lecture or presentation, which may be live or pre-recorded. In other embodiments, the first window can provide text passages from a book, article, or other publication, or text from a website. The text in the first window may scroll automatically during a “playback” operation or the user may manually scroll through lines of text, e.g., using a vertical scroll bar. If the window scrolls during playback, the user can be provided an option to pause the playback so as to highlight a word, phrase, or excerpt so as to perform a selected communication function.

### Creating a Branched Tree Based on Drill Down Operations

In utilizing the system a user may opt to continue drilling-down on information in a serial manner (e.g., seeking to define a term from a passage, then seeking to define a term from the definition, then seeking a define a term from that definition, etc.). Alternatively or additionally, the user may opt to drill-down separately on different text within the same level of information (e.g., seeking to define a term from a passage, then seeking the etymology for a different term from the same passage). As will be illustrated and described in further detail below with reference to FIG.s, multiple drill-downs on the same level of information can be represented as different branches of a tree. This chronologically organizes the user's traversal through the information in a manner that can be more easily understood so that the user can track his or her investigative process.

### Asynchronous Learning System

In some embodiments, the features for facilitating drill-downs and tracking the user's traversal are incorporated into a networked, software-based asynchronous system that is conducive to conducting, organizing, and archiving interactive, yet asynchronous, discussions among a group. This system can be used for various applications as a supplement to, or replacement for, having live communications among a group. As examples, this system can be used for providing educational courses, for conducting meetings and other business communications, for conducting interviews such as for employment opportunities or for admission to universities, or for communications in social settings. More particularly, the asynchronous communication system can maintain and facilitate an evolving set of video and text-based content that can provide a full-on replacement/asynchronous video alternative to a meeting environment (e.g., classroom, in-person meeting, web meeting, etc.) itself. This provides an alternative to the meeting environment eliminating the need for scheduling a fixed meeting time or meeting place.

In some embodiments, the asynchronous communication system centers around a video messaging system that provides structured video messages (e.g., “threads”) that are created by a first user and/or other used and exchanged and expanded over time amongst them. The asynchronous communication system allows any participant to compose and deliver threads to subgroups of users (e.g., user to user, user to several users, first user to second user and other users). As described in detail herein, the asynchronous communication system can be used in a number of different application settings such as a corporate environment such as corporate interviews or meetings, a dating website, a classroom setting, and the like.

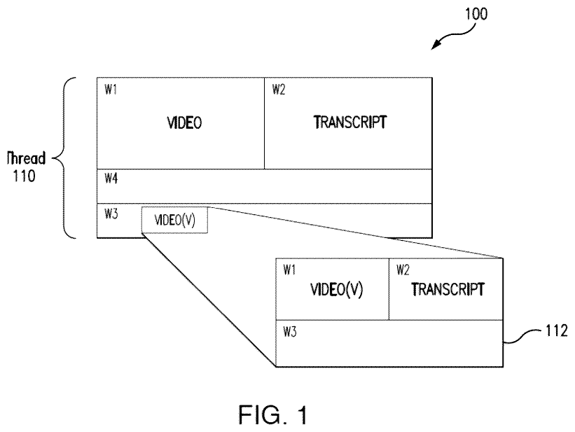

FIG. 1 is a block diagram 100 illustrating an example message thread generated using an asynchronous learning system 304 according to at least one embodiment. The example message thread 110 includes a playable video component W1 including audio of spoken words, a synced transcript W2 of those spoken words as a first window of textual information, and a reserved space W3 that can embed another message thread 112 or provide a second window for additional textual information based on a selected word, phrase, or excerpt from the textual information in W2. The message thread 110 can be archived or saved in a data store 310 or provided to other users of the asynchronous communication system 304. The message thread 110 can be displayed to a user via an interactive GUI. A user that originates a given message thread (e.g., thread 110, thread 112) is an originator of that message thread. Message threads 110, 112 can be generated by an originator through annotation of the interactive GUI. For example, by right-clicking any video appearing anywhere in a given thread, a user can originate a new thread (e.g., thread 112) by right-clicking on a video to pull it into a new W1 as the subject for the new thread.

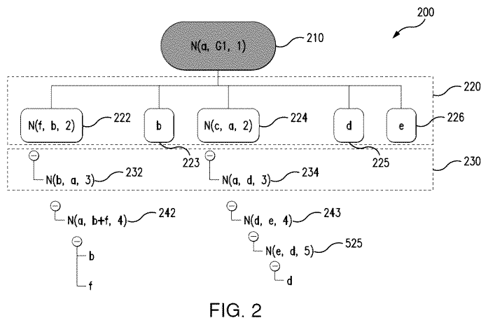

FIG. 2 is a block diagram illustrating an example data structure 200 for generated message threads 110 within an asynchronous learning system 304. As previously discussed in FIG. 1, a user (e.g., an originator) generates a message thread 110 with components W1, W2, W3, and sends that thread 110 to a group of users (G1): users a, b, c, d, e, f, etc. in FIG. 2. When a user annotates a synced transcript W2 at a timestamp T of the video W1, that video W1 and transcript W2 are tagged by the user, along with that user's questions, lookup, notes, and the like in W3. This is denoted in the message as Mx+Tx, where x represents the number of the marking. A node “N” is used to represent W1/W2/W3, the originator (e.g., sending user), the subscribers (e.g., receiving users), and Mx+Tx. Every window vertically in a given thread may contain W1/W2 in addition to its W3. In other words, every window such as W4 may contain its own recoding video, transcription, messages, and M+T. Therefore, every node can be structured with W1/W2/W3 at all levels of a communication.

Such a node is denoted mathematically or symbolically as: N(x, y, z), where N represents a node, x represents a sending user (e.g., originator), y represents one or more receiving users (e.g., recipients), and z represents a level (or depth) of windows counting from W1/W2/W3 at level 1, W4 at level 2, and Wx at level Z. More specifically, the data structure 200 in FIG. 2 is an acyclic recursion of connected nodes (e.g., N(x, y, z)) starting from z=1 down to level Z. At each level z, there could be 1 or many nodes sent from user x to user y. In FIG. 2, a node 110 is a window containing W1/W2/W3. This window is sent from user a to group G1 at tree (thread) level 1 (e.g., level 220). Likewise, node 222 (e.g., N(f, b, 2)) is a window sent from user f to user b at level 2 (e.g., level 230) upon receiving N(a, G1, 1). Group G1 is the recipient group at level 1 (e.g., level 200), which includes user b, c, d, e, f. User f in turn sends a node 222 (e.g., N(f, b, 2)), and user c sends node 224 (e.g., N(c, a, 2)). However, recipient users b, d, e did not respond by sending any node upon receiving N(a, G1, 1). As such, users b, d, e are each a terminal node containing only their user ID. In other words, nodes 223, 225, 226 are terminal nodes. Such terminal nodes are also called leaf nodes in a tree.

Each node within data structure 200 includes various permissions (e.g., visibility) of each user. More specifically, user a can see any nodes containing markings of a as well as the originating node (e.g., nodes 210 224, 232, 234, 242. User b can see any nodes containing markings of b as well as the originating node (e.g., nodes 210, 222, 232, 242). User c can see any nodes containing markings of c as well as the originating node (e.g., nodes 210, 224). User d can see any nodes containing markings of d as well as the originating node (e.g., nodes 210, 234, 243, 252). User e can see any nodes containing markings of e as well as the originating node (e.g., nodes 210, 243, 252). User f can see any nodes containing markings of f as well as the originating node (e.g., nodes 210, 222, 242).

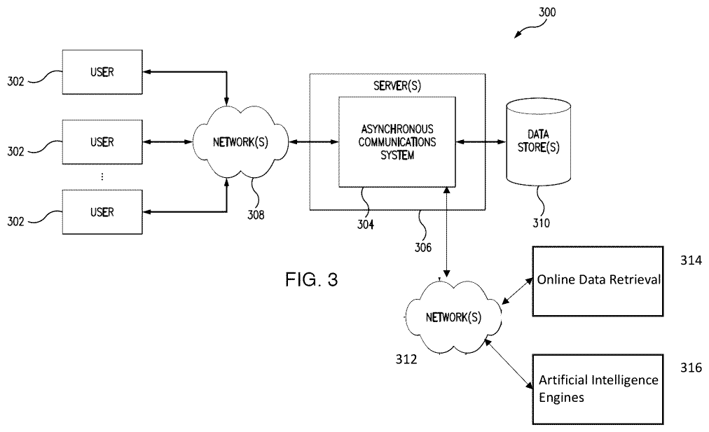

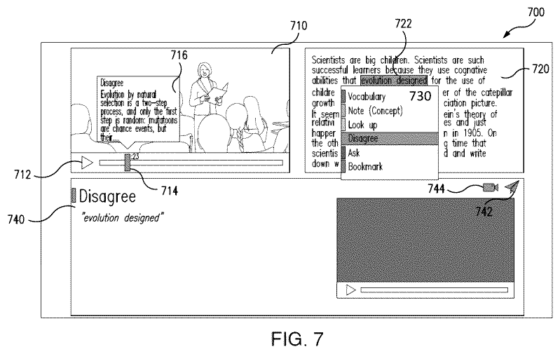

FIG. 3 illustrates an example computer-implemented environment 300 wherein users 302 can interact with an asynchronous learning system 304 for maintaining and facilitating an evolving set of video and text-based content as described herein, hosted on one or more servers 306 through a network 308. Alternatively, or additionally, system 304 may be configured to distribute communications among selected users whereby those users can generate and distribute new content based upon received communications. The asynchronous learning system 304 can assist the users 302 with interfacing between an object-oriented modeling language-based interface and a hardware description language-based interface. For example, users 302 can use the asynchronous communication system 304 to receive information, participate in a dialogue to comment, and/or augment the information being shared, and create additional conversations. Particularly, this is done using one or more datastores 310 containing at least three types of information: audio, visual, and written. A primary video communication is made available to users 302 along with a synced transcript. Authorized users (e.g., a subset of users 302) can access the video and/or synced transcript and use a graphical user interface (GUI) to perform communications functions (including annotations) on the synced transcript. For example, users can designate certain excerpts of the video/transcript, prepare annotations, take notes, request definitions, ask questions, indicate disagreement, and the like. Such communications functions are described in more detail in FIGS. 7-11. As mentioned above and described in further detail below, users can select communications functions to drill-down and obtain more information regarding particular words, phrases, or excerpts of interest, and can do so based on selections of any text in any window of textual information.

A user 302 can designate instances in which the user performed these communications functions to be associated with the user's account, and/or the user 302 can share any of them with other users. The users 302 can interact with the asynchronous learning system 304 and/or other users 302 through several ways, such as over one or more networks 308. One or more servers 306 accessible through the network(s) 308 can host the asynchronous learning system 304. For example, server 306 can maintain asynchronous annotations of communicated content such as a post of a primary video communication, a synched transcript of the video communication, and any number of user annotations made in response to the primary video communication. The one or more servers 306 can also contain or have access to one or more data stores 310 for storing data for the asynchronous learning system 304. Additionally, or alternatively, server 306 may be configured to maintain a plurality of asynchronous communicated content. A communicated content may include a video communication, a transcript synchronized to at least a part of an audio track of the video communication, a distribution list of recipients of the communicated content, and any annotations made to the communicated content. Through annotation of an interactive graphical user interface (GUI), which may be operable on a device of a user, users 302 can access a personalized page of the asynchronous annotations of the communicated content. The device of a user may be in communication with the server to access communicated content received by the user. The personalized page can enable a user 302 to access the communicated content. The interactive GUI can be responsive to various annotations of the user 302 such as (i) designating excerpts from the synched transcript for quick access, (ii) generating notes prepared by the user regarding the communicated content, and (iii) generating textual, audio, or video responses to the communicated content to be posted via the server 106 to the GUI associated with one or more users 302.

As shown in FIG. 7 below, in some embodiments, the GUI may include a video region for playing a video communication of communicated content, a transcript region for displaying at least a part of the transcript synchronized to an audio track of the video communication, and an interactive menu having annotation options for the user to select that is responsive to the user (i) highlighting a text excerpt from the synchronized transcript, (ii) selecting at least one of the asynchronous annotation options, and (iii) generating an annotation to be associated with the highlighted text excerpt.

In additional embodiments, the asynchronous learning system 304 can communicate through networks 312 to retrieve additional information from third parties in response to users' requests. For example, when a user selects text and requests a definition, the asynchronous learning system 304 can connect via networks 312 to one or more online data retrieval sources 314, such as one or more online dictionaries. Additionally or alternatively, a user request for additional information may trigger the asynchronous learning system 304 to connect to one or more artificial intelligence engines 316 for dynamically generating responsive information. The third party information can be reformatted and provided in a window (W3) for the user to review.

The asynchronous learning system 304 is an example flexible information transversal (FIT) system that facilitates users 302 to digest information at their own pace. Such a system allows users 302 to interactively alter an original communication medium (e.g., audio, visual, or written element) into a record of their transversal. More specifically, an original communication medium can be transformed by one or more users 302 through annotations, underlines, highlighting, bookmarking or dogearing, and/or marginalia.

One example application of the asynchronous learning system 304 is in a collegiate environment. In a collegiate environment, users 302 (e.g., students) can individually dissect and/or analyze lecture videos (e.g., pre-recorded videos or livestreamed video) that they receive from a lecturer (e.g., professor, teaching assistant, and the like) or other students in class. Those individually dissected videos can then be transmitted to other students or back to the lecturer for further analysis and discussion.

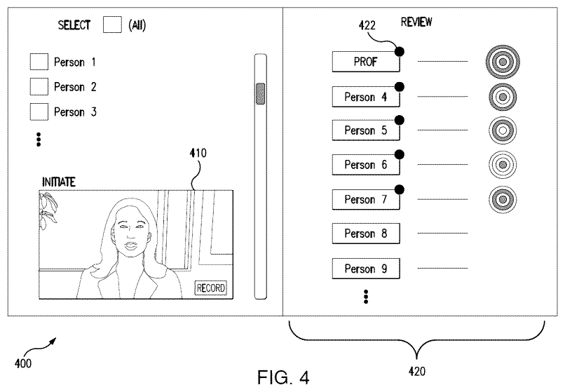

FIG. 4 is an example screen 400 of an interactive GUI of an asynchronous learning system 304. In the collegiate setting, a class can include a professor and a plurality of students (e.g., Person 4, Person 5, Person 6, Person 7, Person 8, Person 9, etc.). The screen 400 includes a primary video communication 410 that can be recorded by a professor. That primary video communication 410 can then be distributed to the students of the class via a video messaging inbox 420 that contains structured video messages or threads. Each user can receive a prompt 422 alerting them that a structured video thread awaits their review.

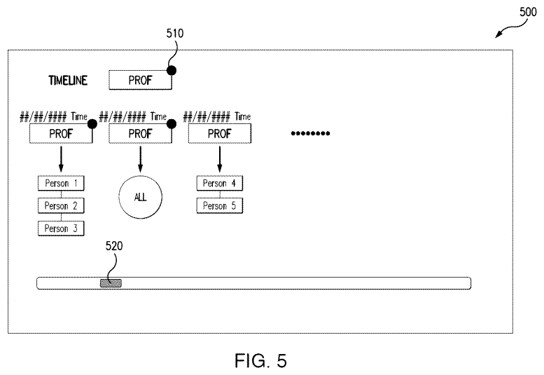

FIG. 5 is another example screen 500 of an interactive GUI displaying an example timeline of generated threads having message alerts 510. A professor can originate a first thread. That thread can be distributed to a subset of students in the class (e.g., Person 1, Person 2, and Person 3) at a first timestamp (e.g., ##/##/## at TIME). At a second timestamp (e.g., ##/##/## at TIME), the professor can distribute the thread to the entire class. At a third timestamp, the professor can distribute the thread to another subset of students in the class (e.g., Person 4, Person 5). This distribution process can continue indefinitely. Interactive scroll bar 520 can be annotated by a user to scroll left or right on the timeline. A left scroll moves the timeline back in time relative to a current time displaying on the timeline. A right scroll moves the timeline forward in time relative to a current time displaying on the timeline.

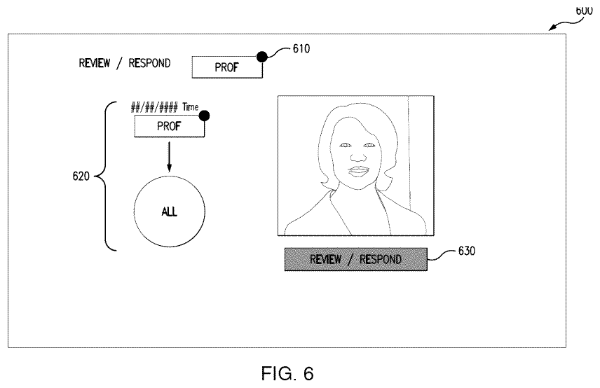

FIG. 6 is another example screen 600 of an interactive GUI of a recipient user of a thread. For example, a user can receive a prompt 610 to review/respond to the professor's thread. The interactive GUI also displays a notification 620 of which users received the thread. The user can annotate the screen 600 by selecting the review/respond radio button 630 to review the thread from the professor and/or respond to it.

FIG. 7 is another example screen 700 of an interactive GUI displaying a menu of communication function options available to the user with the user selecting a “Disagree” option. Screen 700 can be, for example, a personalized page for the user that enables the user to interact with communicated content (e.g., the primary video communication 410 from the professor). The screen 700 includes a playable video component 710 (i.e., a video region for playing a video communication of communicated content) that can be interactively played, paused, and/or stopped in response to the user interfacing with playback feature buttons 712. The screen 700 can also include a synced transcript 720 that is synced to the playable video component 710 (i.e., a transcript region for displaying at least a part of the transcript synchronized to an audio track of the video communication). The user can interface with the interactive GUI using, for example, an interactive menu 730. Menu 730 lists a number of potential communication functions available (e.g., interaction or annotation options for users to select) such as “Vocabulary,” “Note (Concept),” “Look up,” “Disagree,” “Ask,” or “Bookmark.” In the example screen 700 of FIG. 7, a user selects and highlights a portion 722 of the synced transcript 720 (i.e., text excerpt from the synchronized transcript) that they disagree with. The user then selects the “Disagree” communication function 732, an asynchronous communication function option, from menu 730, which can be color coded with the color red. This portion 722 can also be highlighted in red (e.g., the color corresponding to the “Disagree” user annotation 732 on menu 730) to illustrate to the user that the particular user annotation was selected. This portion 722 is flagged at a timestamp 714 of the playable video component 710 and a message thread (as explained in detail in FIGS. 1-2) is generated. After the annotation is generated and associated with the highlighted text excerpt, other viewers can be alerted of this user annotation via their video messaging inbox 420 and can subsequently review/respond to the user's annotation in the same manner described in FIG. 4 . . . . Additionally, an animated pop-up 716 can illustrate the user annotation on the playable video component 710 at the timestamp 714 that is synced with the portion 722 of the synced transcript 720. In other words, the annotation options are responsive to the user (i) highlighting a text excerpt from the synchronized transcript, (ii) selecting at least one of the asynchronous communication function options, and (iii) generating an annotation or providing information to be associated with the highlighted text excerpt.

Screen 700 also includes a summary section 740 highlighting the user's selection from the menu to indicate disagreement and the portion 722 of the synced transcript 720. The summary section 740 also includes a send option 742 that facilitates sending the user's interaction and annotation to other users' video messaging inbox 420. Additionally, summary section 740 includes a video jump to option 744 that allows the user to view the relevant timestamp 714 of the playable video component 710.

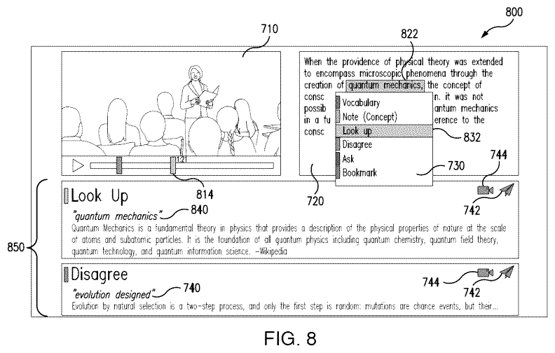

FIG. 8 is another example screen 800 of an interactive GUI displaying annotation options available to the user with the user selecting a “look up” option. Example screen 800 has similar components to screen 700 of FIG. 7. In FIG. 8, the user selects and highlights a portion 822 of the synced transcript 720. The user then selects the “Look up” user communication function 832 from menu 730, which in turn provides a dictionary definition of the portion 822 (e.g., term “quantum mechanics”) in the summary screen 850. Alternative to, or in addition to, retrieving a dictionary definition from a dictionary source, the annotation may include content retrieved from other third-party sources, such as Wikipedia, social media, or intranet/internet (e.g., Google). The retrieved content may be selected based on the highlighted portion 822. For example, a text excerpt from the highest ranked Wikipedia entry using highlighted portion 822 as search terms may be included in the annotation. As shown in FIG. 8, the “Look up” user annotation 832 is associated with the color green on menu 832. The portion 822 can also be highlighted in green (e.g., the color corresponding to the “Look up” user annotation 832 on menu 830) to illustrate to the user that the particular user communication function associated with that text was selected. In some cases, the dictionary definition can be a pre-stored definition within data store 310. In other cases, the dictionary definition can be provided by an external source such as a website via network 308. This portion 822 is flagged at a timestamp 814 of the playable video component 710 and a message thread (as explained in detail in FIGS. 1-2) is generated. Other viewers can be alerted of this user interaction via their video messaging inbox 420 and can subsequently review/respond to the user's interaction in the same manner described in FIG. 4.

Screen 800 also includes a cumulative summary 850 of user annotations and other interactions based on the communications functions selected to date, including in this example, (i) a summary section 840 highlighting the user annotation of the look-up along with the portion 822 of the synced transcript 722 and the relevant definition and (ii) a summary section 740 highlighting the user annotation of the disagreement previously entered as described in FIG. 7 along with the portion 722 of the synced transcript 720. In some embodiments, the interactive graphical user interface is configured to display annotations and interactions that are associated with the displayed portion of the transcript. In some embodiments, the display annotations and interactions may have been generated by the user and/or other users on the system.

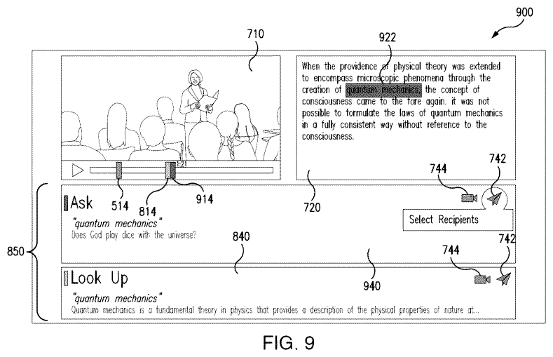

FIG. 9 is an example screen 900 of an interactive GUI displaying an interaction by the user after having selected an “Ask” option. Example screen 900 has similar components to screen 700 of FIG. 7. In FIG. 9, the user selects and highlights a portion 922 of the synced transcript 720. The user then selects the “Ask” user interaction from menu 730 (not shown), which in turn prompts a communication function in which a user is prompted to enter a question regarding the portion 922 of the synced transcript 720. In an example, the “Ask” communication function on menu 730 is associated with the color orange. The portion 922 can also be highlighted in orange (e.g., the color corresponding to the “Ask” user communication function on menu 730) to illustrate to the user that the particular user function was selected. This portion 922 is flagged at a timestamp 914 of the playable video component 710 and a message thread (as explained in detail in FIGS. 1-2) is generated. Other viewers can be alerted of this user interaction via their video messaging inbox 420 and can subsequently review/respond to the user's interaction in the same manner described in FIG. 4.

Screen 900 also includes a cumulative summary 850 of user interactions to date including (i) a summary section 940 highlighting the user interaction of asking a question along with the portion 922 of the synced transcript 722 and (ii) a summary section 840 highlighting the user interaction of the look-up along with the portion 822 of the synced transcript 722 and the relevant definition previously described in FIG. 8.

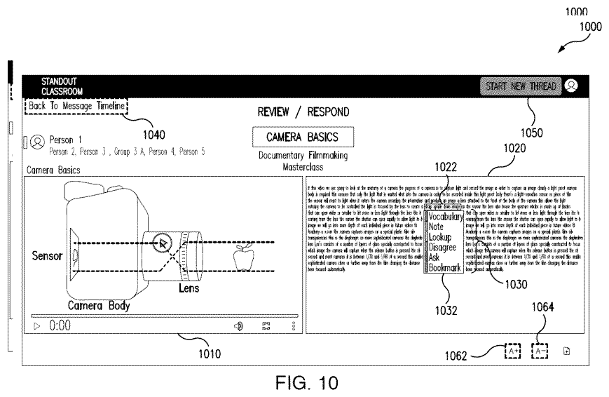

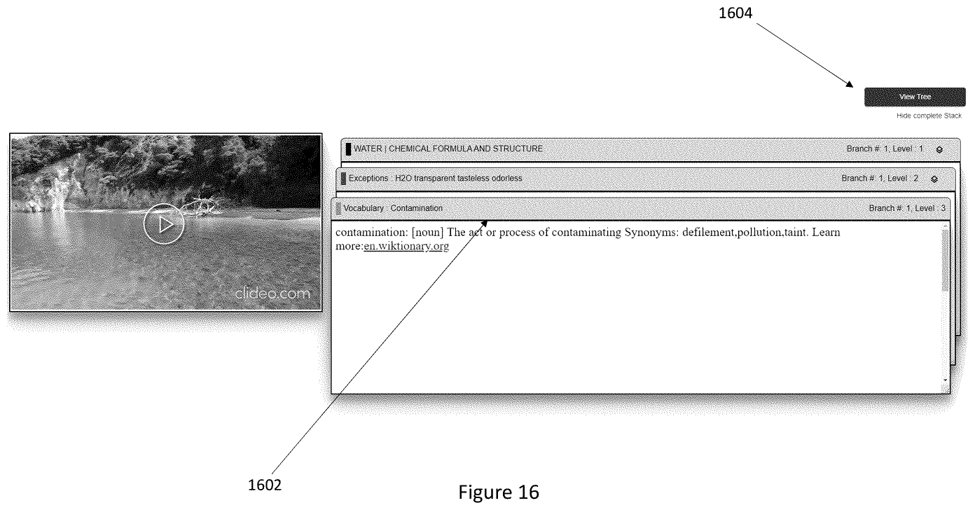

FIG. 10 is another example screen 1000 of an interactive GUI displaying communication function options available to the user with the user selecting the “Ask” option. Screen 1000 can be, for example, a personalized page for the user that enables the user to annotate and/or interact with communicated content. The screen 1000 includes a playable video component 1010 that can be interactively played, paused, and/or stopped in response to the user interfacing with playback feature buttons that appear when the user hovers over the playable video component 1010 with a pointer device (e.g., playback features 1612 of FIG. 16). The screen 1000 can also include a synced transcript 1020 that is synced to the playable video component 1010. The user can increase the font size of the synced transcript 1020 by selecting the increase font feature 1062. The user can decrease the font size of the synced transcript 1020 by selecting the decrease font feature 1064. The user can interface with the interactive GUI using, for example, menu 1030. Menu 1030 lists a number of potential user annotations available such as “Vocabulary,” “Note,” “Look up,” “Disagree,” “Ask,” or “Bookmark.” In the example screen 1000 of FIG. 10, a user selects and highlights a portion 1022 of the synced transcript 1020 that they would like to ask a question on. The user then selects the “Ask” user communication function 1032 from menu 1030.

In addition to the user annotations made to the synced transcript 1020, as user can go back to the message inbox or message timeline, by selecting the back feature 1040. A user can also start a new thread by selecting the radio button 1050.

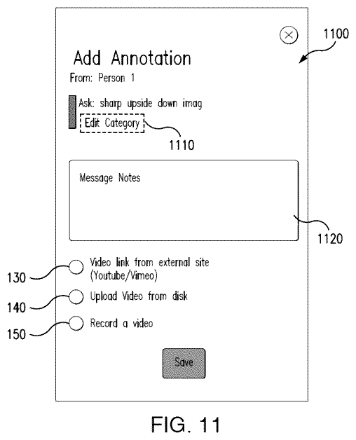

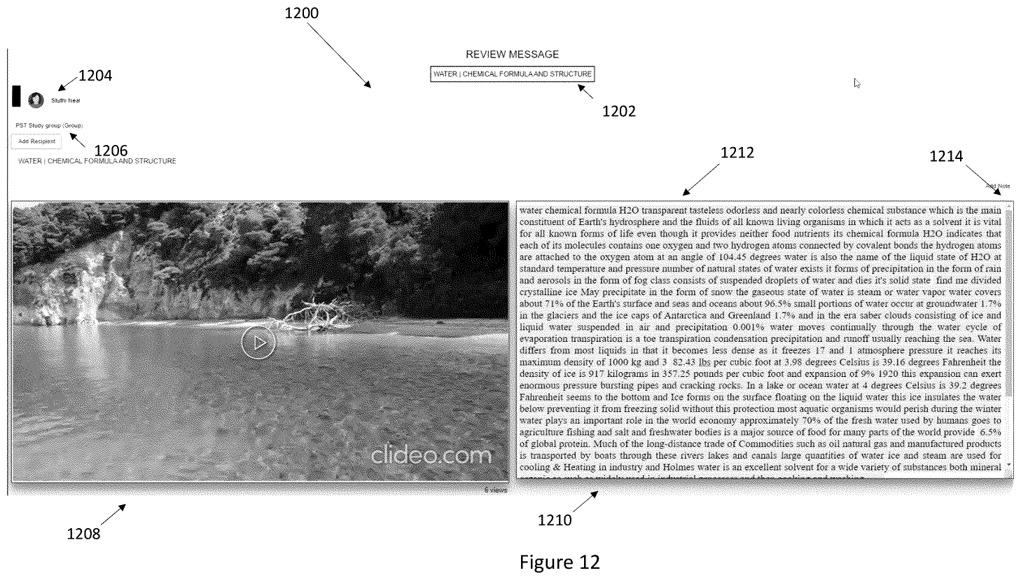

FIG. 11 is an example screen 1100 of an interactive GUI displaying submitting an annotation, in this case, a question. A user selecting, for example, the user communication function for “Ask” 1032 can then be prompted with the screen 1100. Screen 1100 solicits further input from a user for the annotation, that is, to submit the question. Using screen 1100 a user can change the type of user communication option by selecting feature 1110 (e.g., Edit Category). By selecting feature 1110, a user can change the user communication function of “Ask” to any other available user communication function (e.g., as “Vocabulary,” “Note,” “Look up,” “Disagree,” or “Bookmark”). In the example illustrated in FIG. 11, the user keeps the user option 1032 of “Ask.” The user can then enter in a question by typing into the entry box 1120. An example question from a user is illustrated by example screen 1200 of FIG. 12. For example, a user can ask the question “Why is the image upside down?”

Additionally or alternatively, the user can select any of the radio buttons 1130, 1140, 1150 in the example screen 1100 to add video to the interaction. For example, by selecting radio button 1130 a user can add in a video link from an external site. By selecting radio button 1140 a user can upload a video from another location using an explorer window. By selecting radio button 1150, a user can record a video to upload. The user can select a radio button 1310 to start a video capture. The user can either delete the captured video or change the video source to one of the other available options (e.g., upload video from another location or add in a video link from an external site) using radio option 1320. The user can save the interaction by selecting radio button 1330.

### Incorporating Fractal Menuing in the Asynchronous Learning System

FIG. 12 illustrates a graphical user interface (GUI) 1200 that has been configured for use with a fractal menu. In this example, the title of the page 1202 is “WATER|CHEMICAL FORMULA AND STRUCTURE,” indicating the subject matter of the discussion. The graphical user interface is provided to a particular user 1204, who is a member of a user group 1206 of recipients. As shown, there are two windows, 1208 (W1) and 1210 (W2) (according to the data structure described with reference to FIG. 1), where the window on the left provides a narrated instructional video (upon hitting the play button, using a media player), and the window on the right provides a transcription of the narration 1212 (which can be automatically generated via a plug-in for transcribing the audio of a media file). The transcription window 1210 can include a vertical scroll bar 1214 that can be configured to automatically scroll through the transcription as the media (video) in the left window (W1) is played, or can be manually scrolled when the media is paused or concluded.

The graphical user interface as depicted in FIG. 12 thereby enables a user to benefit both from video (images), audio, and text representations of information to be learned in a course of study. Alternatively, the text in W2 need not be a transcription of the video W1. The text in W2 can be reference material, perhaps from a textbook, article, or other publication, or could be provided via a website. In some embodiments, the video W1 could be optional or simply not included.

Additionally, the graphical user interface of FIG. 12 can be configured to be provided only to subscribers 1204, such as members of a defined group 1206, so as to provide for asynchronous learning in an academic setting to a virtual class. In alternative embodiments, the graphical user interface can be provided without necessitating subscribers, defined groups or teams. As an example, the graphical user interface can be incorporated into a web browser for enabling a novel way to view and read textual information of material made available online. In another embodiment, the graphical user interface can be incorporated into an online reading interface (such as a Kindle) without video or audio. In various embodiments, the textual information need not be a transcription of a video, but rather, it can be any textual material to be reviewed by one or more users for their edification or entertainment. Accordingly, the window (W1) providing media for playback is optional.

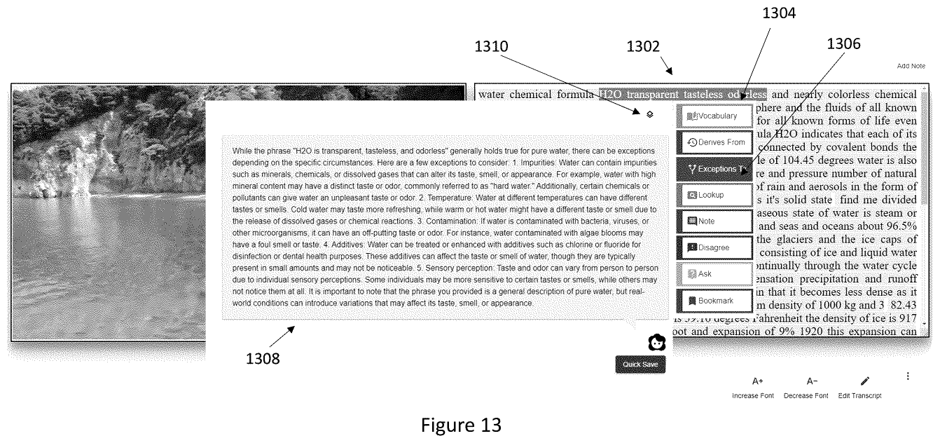

FIG. 13 illustrates an example of how the graphical user interface 1200 of FIG. 12 is configured to respond to a first level drill down operation, according to various embodiments. As can seen, the display may provide a window 1208 (W1) for video and window 1210 (W2) for text. In response to a user selecting to highlight a passage of text 1302 using a cursor, the window 1210 is now an annotated window. Upon the user making the selection, a menu 1304 can automatically appear on the display, which provides a group of options for the user to select. In this example, menu 1304 provides options for “Vocabulary,” “Derives From,” “Exceptions To,” “Lookup,” “Note,” “Disagree,” “Ask,” and “Bookmark.” Each of these options is color-coded and each provides a communications function that causes additional interactions to occur with the asynchronous learning system. Particularly, communications functions can enable the user to “drill down” on a word, phrase, or excerpt from the text in window 1208 so as to receive additional information or explanation, provide a framework by which the user can take notes or bookmark something of interest so as to find it more easily later, or launch a question to be asked, for example, to a teacher or professor who is providing the text as part of a course of study.

In the example of FIG. 13, the user selects the “Exceptions To” tab 1306 in the menu 1304, which is a prompt to the asynchronous learning system to provide additional information about what exceptions there may be to the statement or principle being conveyed by the selected text, phrase, or excerpt that the user caused to be highlighted in window 1208 (W2). In response to selecting this tab 1306, a new window 1308 appears with additional text, which provides a textual explanation that is responsive to the prompt. In this example, the user is seeking to learn what exceptions there are to an excerpt in the text passage referring to “H2O transparent, tasteless, odorless.” In response, a new text passage is automatically generated explaining various exceptions, including “1. Impurities,” “2. Temperature,” “3. Contamination,” “4. Additives,” “5. Sensory Perception.”

The new window 1308 that is generated in response to selecting a tab in menu 1304 can be provided from any of various sources, such as, the faculty member that assigned the text in 1208, a textbook associated with a course, other reference material, one or more automated results from running a search for “exceptions to” and the selected excerpt in a search engine, or a result from running the query in an artificial intelligence engine. Whatever the source, the operations in response to the user's prompt for a communication function can be automated and transparent to the user. In this example, in response to the user's selection of a communication function, the responsive additional information is provided on the same screen of the graphical user interface (overlaying W1 and W2) without any additional actions needed from the user. In some embodiments, the user can move the pop up 1308 by drag-and-drop across other areas of the screen. Additionally, the user can save or discard the additional information (see the “Quick Save” tab on 1308).

To preserve the additional information and archive that the communication function was performed, the user can select (or click on) icon 1310, which is a “stack feature.” By stacking this information, a new window (W3) will be generated that has the information and, as a different level of information, and that new window will be associated with window 1208 so as to define the user's traversal through information as part of the user's course of study.

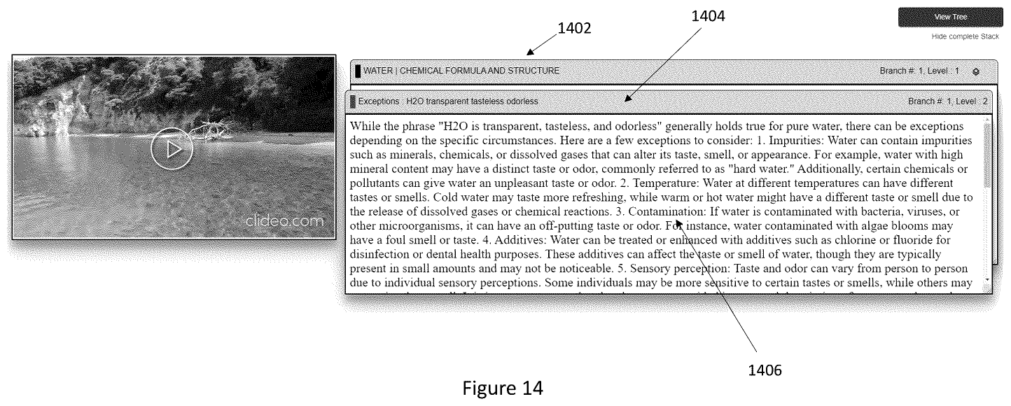

FIG. 14 illustrates how the text information in pop up 1308 is “stacked” in response to the GUI receiving a user-selection to “stack” the additional information. This can be referred to as a “stacked view.” Particularly, in this example, new window 1404 is created and displayed such that it overlays the original window W2 1402, such that the two windows are stacked with reference to each other.

Each window includes a header that, in some embodiments, provides a color coding for the type of communication function, a title for the information or name for the function. For example, window 1402 includes the title of the text passage (“WATER|CHEMICAL FORMULA AND STRUCTURE”). On the right side the header indicates that this window is “Branch #1,Level: 1,” indicating that this is a top-level window, providing the original textual information to be reviewed. The next window 1404 has the name of the communication function, “Exceptions” and is color-coded in a manner that corresponds with the “Exceptions To” tab 1306 in the color-coded menu 1304 as displayed in FIG. 13. The header of 1404 additionally provides the word, phrase, or excerpt 1302 (“H2O transparent tasteless odorless”) that had been selected and highlighted from the text at the top level as shown in FIG. 13. Finally, the right side of header 1404 includes an indication of its relationship to the other window(s), in this case, it is “Branch #1,Level: 2,” indicating that this is part of the same “branch” as window 1210 but it provides additional information at a second level.

In FIG. 14, it can be seen that headers 1404 is not directly under 1402, but rather, it is offset slightly, so as to indicate its relationship to 1402 as being a next level “on top of” the original text window 1210.

In accordance with various embodiments, the graphical user interface enables the user to continue to “drill down” further, using the “fractal menu,” so as to perform communication functions on the additional information that had been generated based upon a prior “drill down” communication function. The graphical user interface is configured so as to provide an easy way for a user to perform these additional drill down operations with minimal effort, and the graphical user interface continues to arrange and organize the additional information being generated so that the user can easily visualize the traversal through the multiple levels of information. In this example, the user will drill down on information in the second level of information from the window having the header 1404.

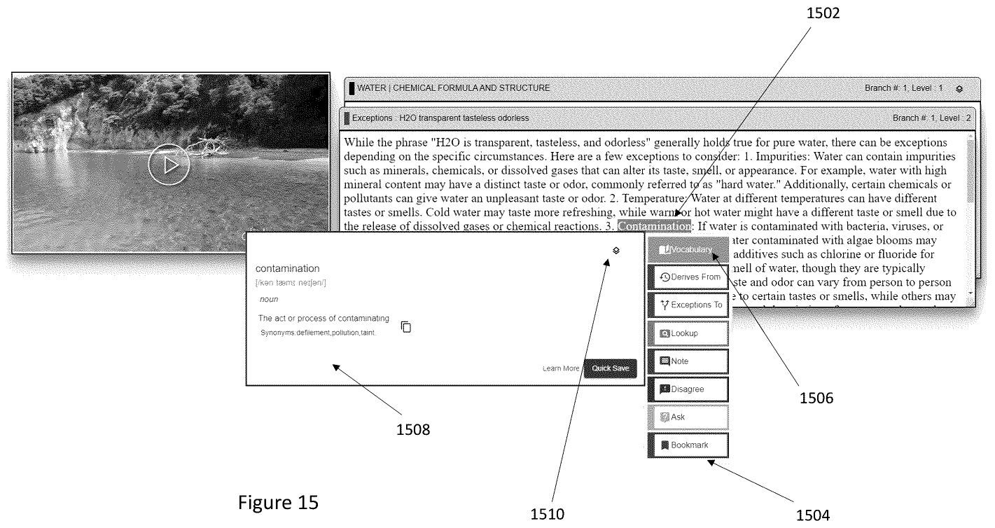

As described above, the text in the new window having the header 1404 provided additional information, particularly, concerning the exceptions to a principle conveyed in the original text window. As an example, it can be seen that one of the exceptions pertains to “3. Contamination” 1406. In this example, the user highlights “Contamination” and, as can be seen in FIG. 15, once that term is selected 1502, the menu 1504 reappears to provide options for the user to select. By selecting the “Vocabulary” option 1506 from the menu 1504, a new window 1508 is generate with a definition for the selected term. The information generated in response to selecting “Vocabulary” can be retrieved from one or more online dictionaries, a textbook associated with a course, or other third-party sources online. As described previously, the user can save this information and/or can select the “stack icon” 1510 to add this into a stacked view.

As a user continues to “drill down” by requesting additional information about text that had been generated from requests for additional information, the user's stack of traversals through the information will continue to grow. FIG. 16 illustrates another stacked view, this time with a window having a third level of information based upon the user's request for a definition of a term that appeared in the second level of information. Particularly, FIG. 16 shows three windows offset from each other, the first two of which were shown in FIG. 14. This time, the third window having header 1602 is further offset from the other two windows. As with the header for the other windows, header 1602 has a color code corresponding to the communication function (“Vocabulary”), the word, phrase or excerpt of text that was selected (“Contamination”) and the relative arrangement of this window to the others in the stack (“Branch #1,Level: 3”). In this case, header 1602 indicates that this window is in the same branch as the other two windows stacked beneath and is the third level of information, meaning that it is based on the text in the window at the second level, which in term is based on text in the window at the first level.

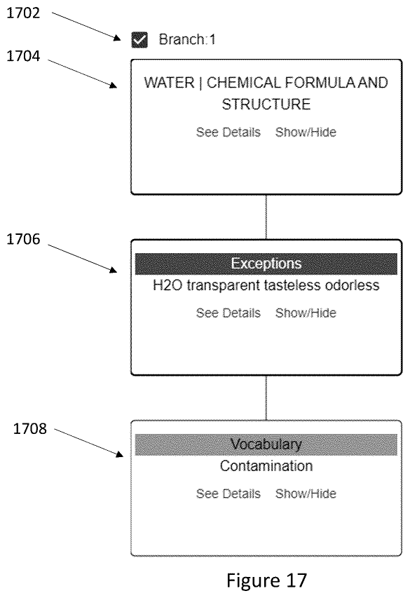

FIG. 16 includes an icon for “View Tree,” which enables a user to operate the graphical user interface to view the information from yet another perspective to better understand the relationships between the text provided in the windows. As shown in FIG. 17, by receiving a user selection for “View Tree,” the graphical user interface generates a tree view, showing that all three windows are in the same branch and at different levels. In particular the branch number (“Branch: 1:”) 1702 has three “leaves” on the branch, 1704, 1706, and 1708, corresponding to the three windows depicted in FIG. 16. The tree view provides information that was presented in the headers for those windows. For each “leaf,” the tree view also enables a user to select to “See Details” or “Show/Hide,” so that the user can view more information about a leaf if desired, or hide information to make the view less crowded. It can be appreciated that as a user continues to select communication functions to receive more information about text, the tree view will grow.

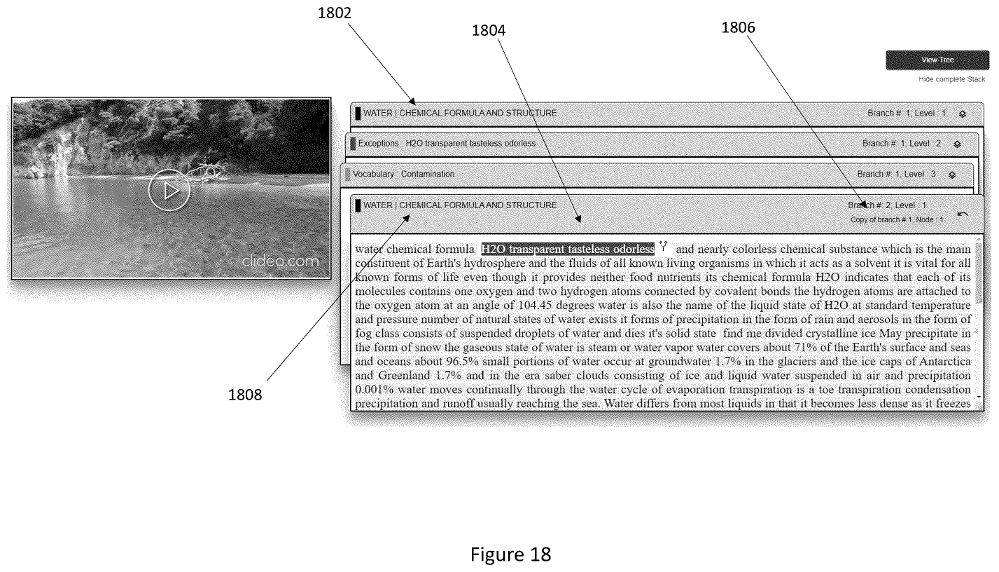

Returning to the stacked view, FIG. 18 illustrates a stacking arrangement when the user selects to create a new branch with information that already was provided. In this example, the new branch 1804 makes a copy of the text from window 1802. As can be seen, the header of 1802 indicates that this is the original window, “Branch #1, Level: 1,” as shown in FIGS. 12-16. A copy is made of the same text, as indicated at 1806 as “Branch #2, Level: 1.” This enables the user to see the prior highlights made to the text (at 1808) and then make additional highlights, selections, and annotations, to generate additional communication functions for the textual information at this level.

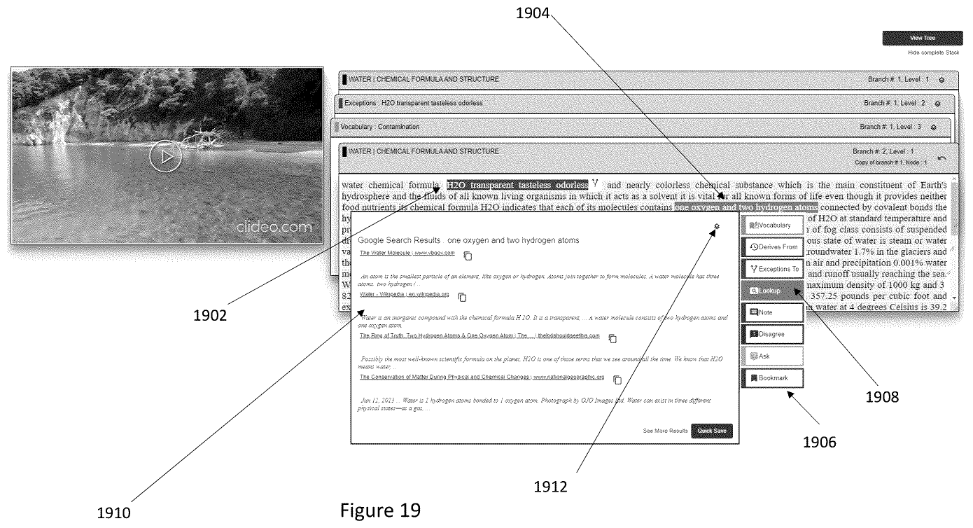

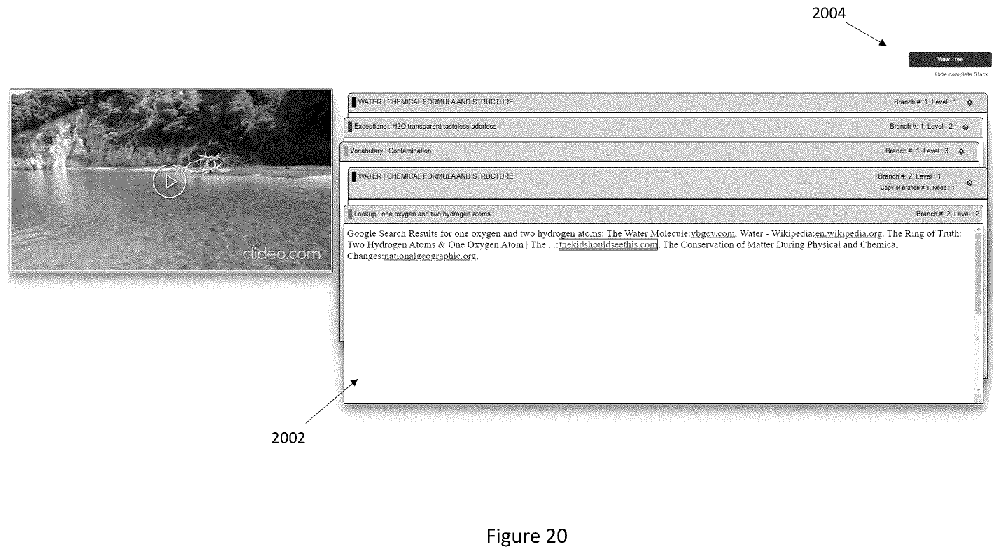

FIG. 19 illustrates an example of a user's interaction with the graphical user interface display of FIG. 18. In the stacked view, the headers of the three windows of Branch #1 continue to be displayed, each offset from each other, but now they are further overlaid with the window for Branch #1, Level: 2 (1804). This FIG. shows that more text from this window was selected by the user (“one oxygen and two hydrogen atoms”) 1904, prompting the graphical user interface to display the menu 1906, from which the user selects the “Lookup” communication function 1908. The “Lookup” function causes the asynchronous learning system to run a query in a search engine (e.g., Google Search) on the selected word, phrase, or excerpt of text from the window. In this case, the system runs a search on “one oxygen and two hydrogen atoms” and displays search results (reformatted and summarized for easy viewing) in a new window 1910 that overlays the window having header 1804. Once again, by receiving a user click on the stack icon 1912, this new window is presented in a stacked view, as shown in FIG. 20.

In FIG. 20, the window 2002 having additional information regarding text from “Branch #2, Level: 1” is presented. As can be seen, the headers of the five windows in the view are each offset from each other, and the offset pattern resets for each branch. The different branches can also be discerned on the graphical user interface by switching to the tree view, by clicking on the “View Tree” icon 2004.

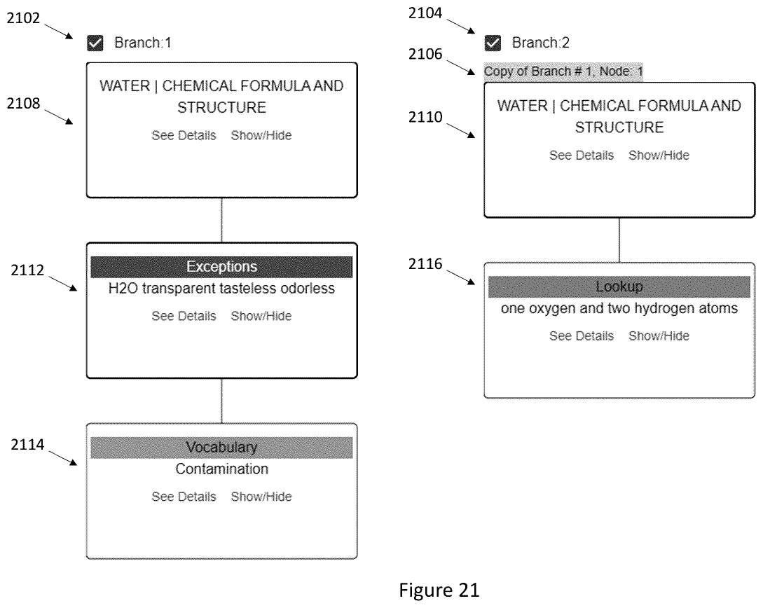

FIG. 21 is an example display of a tree view that includes all of the stacked text windows of FIG. 20. As described above, FIG. 17 showed a tree view of a single branch, based upon the levels of textual information that had been generated at that point. FIG. 21 illustrates the expansion of the tree, now having two branches 2102 and 2104, where the window 2110 in the second branch 2104 is a copy of the window 2108 from Branch #1, Node 1 (or level 1). In the second branch 2104, the window at a second level 2116 was generated based on the “Lookup” communication function. Windows 2112 and 2114 are repeated from that shown in FIG. 17.

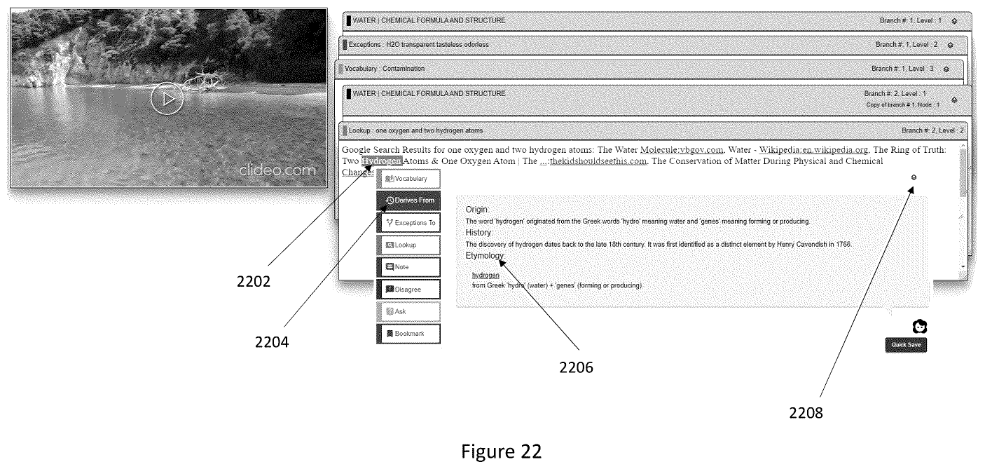

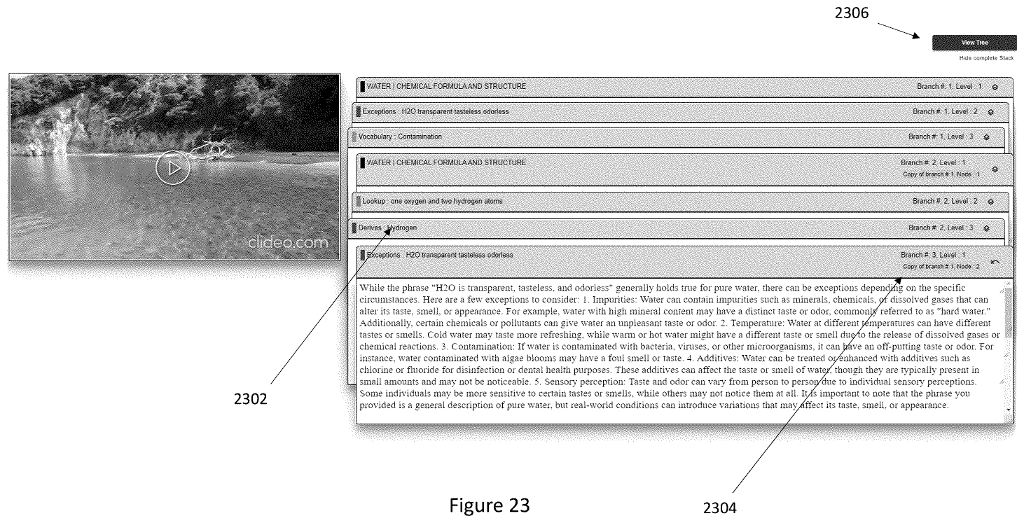

FIG. 22 returns to the stacked layout, now indicating a user selection of the “Derives from” communication function. In this example, the user is seeking additional information from stacked window 2002 (from a “Lookup” communication function), also represented in the tree view as 2116. The user desires more information about the word “Hydrogen” and highlights that term, triggering the menu to pop up, and then the user selects the “Derives from” communication function. This triggers the graphical user interface to generate a new window 2206 providing information about the origin, history, and etymology of the term. Once again, this information can be retrieved from textbooks associated with the course of study or various third-party sources, including from artificial intelligence engines. The graphical user interface can retrieve unformatted text and reformat the information to better suit the user's purposes. By clicking on the stack icon 2208, the user then can be taken to a stacked view with this additional window represented in the stack, as illustrated in FIG. 23 by header 2302 (“Derives: Hydrogen”). Because this new window provides a third level of information from the first level of information in the second branch, the header is identified as Branch #2, Level 3.

FIG. 23 additionally shows the creation of yet another branch, this time as a copy 2304 of the window represented as Branch #1,Node 2. In other words, the user elected to generate a new branch so as to request and obtain additional information from a window generated from text in the previously generated second level of information from the first branch. This adds to the tree of additional information as further drill downs, enabling more communications functions to further the user's understanding of the educational material. As can be seen, this new window is reset from the windows upon which it is stacked, and the pattern is reset because this represents yet another new branch.

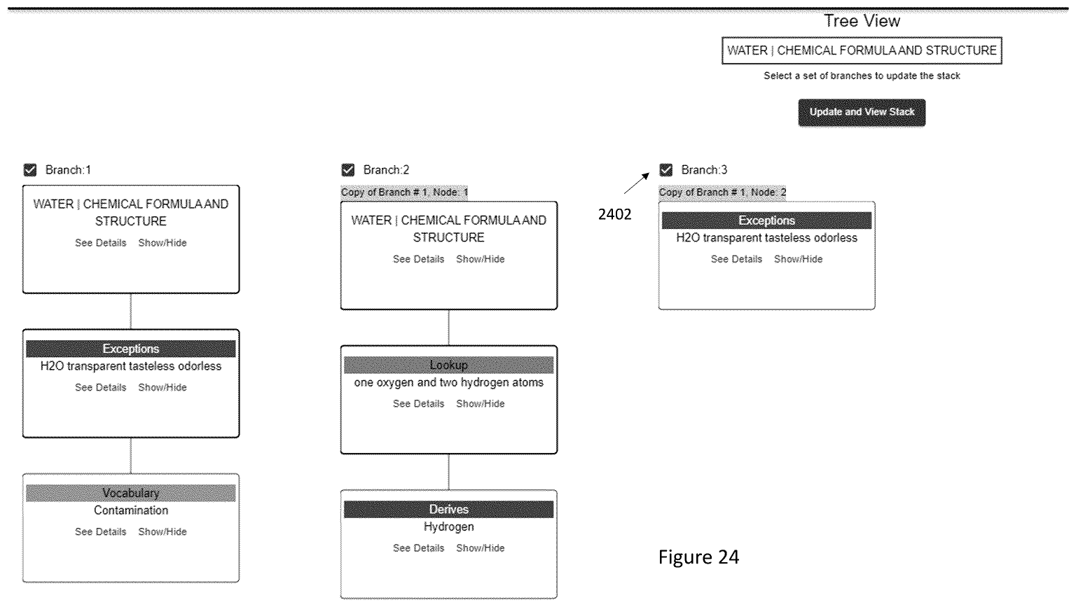

By selecting the tree view icon 2306, the stacked windows are represented in a tree view as shown in FIG. 24. In particular, the window 2304 at the top of the stack in FIG. 23 is now represented as a third branch 2402. As in the tree views in FIGS. 17 and 21, FIG. 24 defaults to providing a representation of each window and an indication of where it fits in the stack, in association with its dependency from text in other windows. The tree view facilitates the user to recognize his or her traversal through the textual information originally provided along with the various additional textual information that was requested as the user selected various communication functions. The tree view also enables the user to easily reopen any of the windows to review the information provided therein.

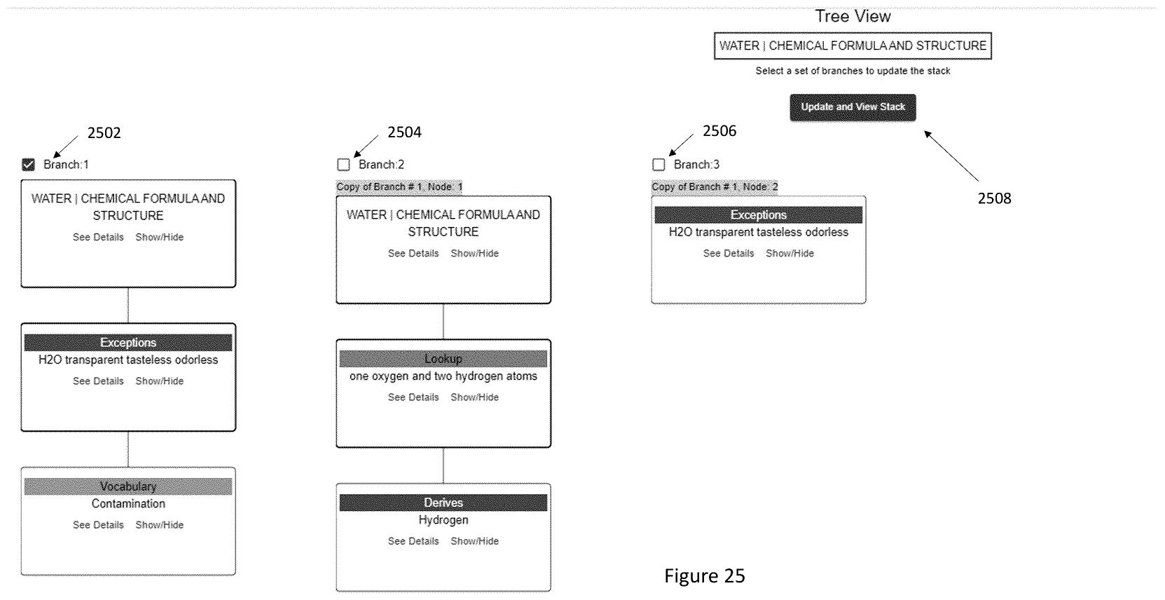

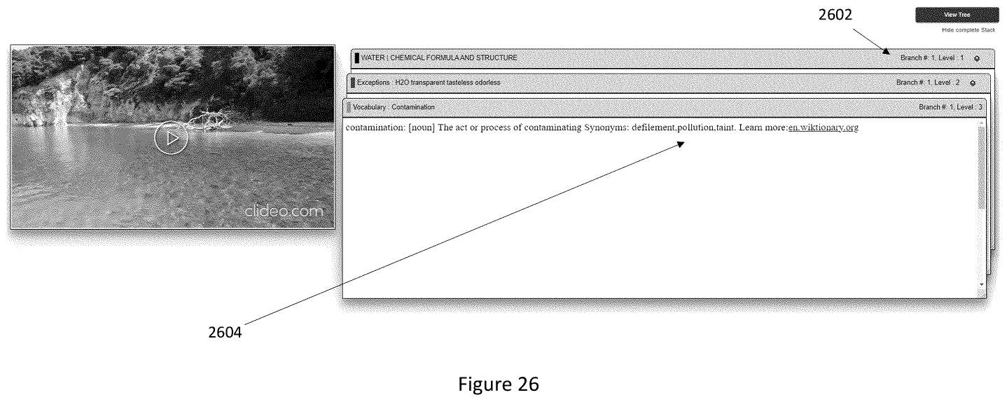

As the tree becomes more complex, the user may decide that it would be preferable to view just some of the branches, so as to avoid confusion or clutter. The graphical user interface enables this as well, by providing toggles at 2502, 2504 and 2506 of FIG. 25. The user can select which of the branches to continue seeing (in this case, the user only wishes to view branch 1). By then clicking on the icon “Update and View Stack” 2508, the graphical user interface will return to the stacked view, as shown in FIG. 26, but this time with just the branch(es) that were selected. FIG. 26 illustrates the graphical user interface with just branch 1, at levels 1, 2, and 3. From here, if desired the user can then continue to drill down on the window 2604 at branch 1, level 3.

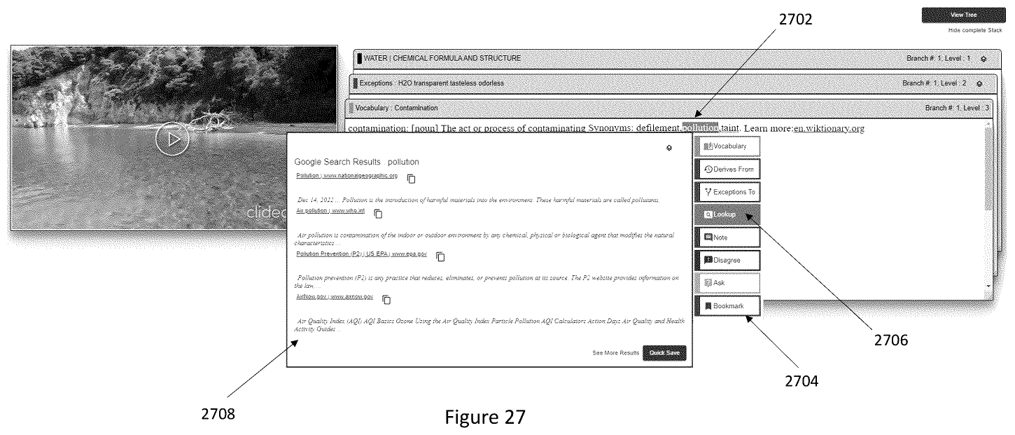

FIG. 27 illustrates a user's interaction with the stacked view of FIG. 26, this time selecting the word “pollution” 2702, which then prompts the interface to display the menu 2704. Upon receiving a selection of the “Lookup” communication function, the system generates window 2708 with Google Search Results for the word “pollution,” in the same as described above.

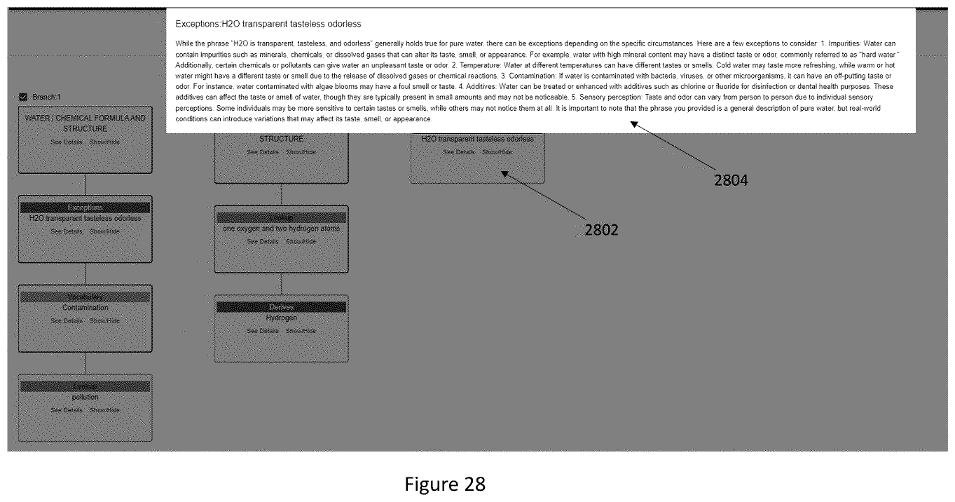

FIG. 28 returns to the tree view and illustrates a window provided in response to a user selecting to receive more detail about one of the displayed nodes. In this example, the user requests to “See Details” about Branch 3, Node 1 (at level 1) 2802, which prompts the graphical user interface to provide the text 2804 in that window. In this manner, a user can review detailed text information either from the stacked view or the tree view.

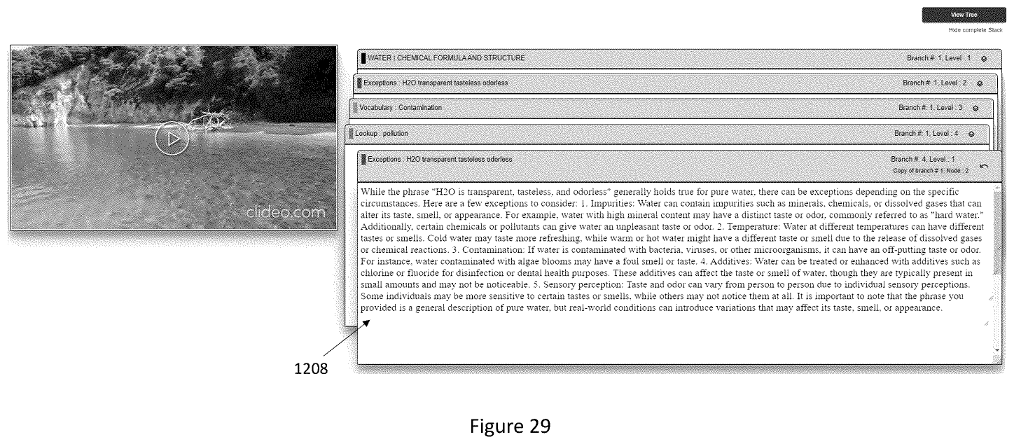

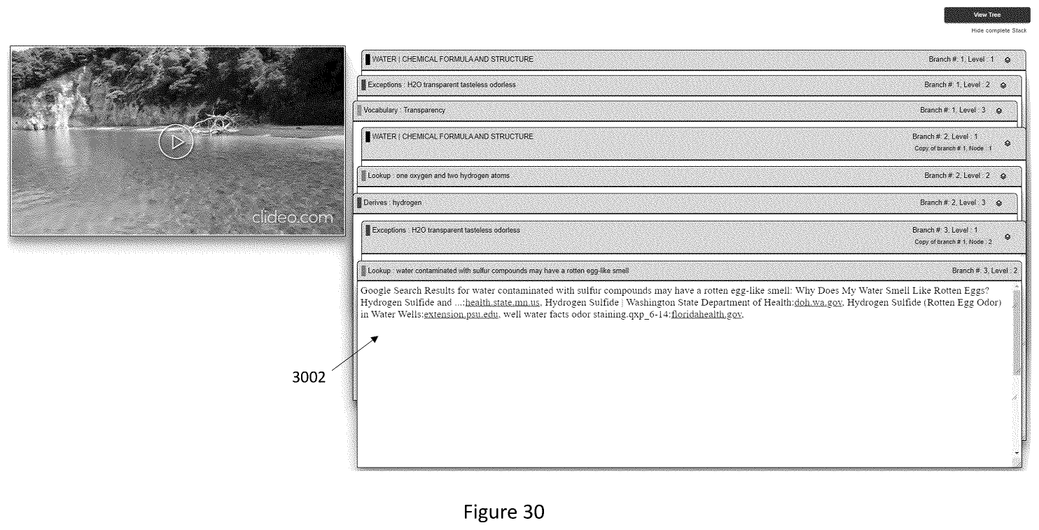

FIG. 29 illustrates the stacked view once again, this time with a fourth branch, which was generated by making another copy of the window associated with branch #1, node 2. The window 1208 can then be used for making additional drill downs on text from that window. From that window, the user highlights a phrase (“water contaminated with sulfur compounds may have a rotten egg-like smell”) and requests a “Lookup” from a fractal menu. This prompts the asynchronous learning system to generate a new window, now at level 2, with search engine results by formulating a query with the selected language, as shown in FIG. 30 (particularly 3002).

From the above FIG.s, which can be screenshots from a graphical user interface implemented based on the asynchronous learning system, it can be discerned that the system enables a user to drill down on any text (any word or phrase) to have a communication function performed and generate additional information. By these means, the user can learn additional information about anything that is being presented, and in turn, the user can question the information provided in response to the user's questions. This capability to continually “drill down” thereby enables a user to fully investigate any aspect of presented reading material to more thoroughly understand the subject matter. Additionally, the graphical user interface presents the information using stacked windows and tree views such that the user can easily understand his or her traversal through the course of study, and organize the views so as to review what work had been done or continue drilling down on items of interest.

As illustrated in the figures, all selections of text, phrases or excerpts of text passages are highlighted as annotations, and these highlights are color-coded according to the user's selection of a communication function from a menu. From this, the user can easily discern what parts of the text peaked his or her interest or generated questions. The user's highlights and the additional windows of information generated at different levels can be shared with others in the user's group or with the user's teacher or professor. For example, when the user selects the “Ask” communication function, the system generates a window for the user to enter a question, which is then communicated to the teacher/professor to generate a response. Similarly, the user can simply select text and then designate it for “notes” or “bookmarks,” which generate empty windows by which the user can enter his or her own information. This information can be private for the user or, if desired, it can be shared with others in the user's group.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random-access memory associated with one or more physical processor cores.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results.

We claim:

1. A communications system for traversing multimedia content that can be augmented in stacked windows of information, the system comprising:
an interactive graphical user interface operable on a device of a user, wherein the device is in communication with a server to access or provide communicated content, and wherein the graphical user interface generates a display that includes in a first window:
a video region for playing a video communication of communicated content,
text associated with the video communication, and
an interactive menu of a plurality of types of communication functions from which the user can select, wherein the graphical user interface is responsive to the user
(i) highlighting a text excerpt, and
(ii) selecting, from the interactive menu, a type of communication function to be associated with the highlighted excerpt,
wherein the graphical user interface augments the communicated content into a second window to be stacked in a manner offset and atop the first window to provide additional information on the user's display based upon the type of function that the user selects from the interactive menu and the highlighted text excerpt from the synchronized transcript, and depending upon the selected type of communication function, wherein the stacked information is created according to branches and levels that can be navigated in forward or reverse order, and
wherein the interactive menu is further responsive to the user highlighting a text excerpt from the second window and selecting a type of communication function, to cause further stacking of additional windows that provide additional information.
